(19) United States
(12) Patent Application Publication
(10) Pub. No.: US 2025/0242771 A1
(43) Pub. Date: Jul. 31, 2025

(54) VEHICLE PROTECTION ADAPTER

(71) Applicant: SCRAPE ARMOR, INC., Bellevue, WA (US)

(72) Inventor: Scott Whitehead, Bellevue, WA (US)

(73) Assignee: SCRAPE ARMOR, INC., Bellevue, WA (US)

(21) Appl. No.: 18/823,224

(22) Filed: Sep. 3, 2024

Related U.S. Application Data
(63) Continuation of application No. 18/087,773, filed on Dec. 22, 2022, now abandoned.
Application No. 18/087,773 is a continuation of application No. 17/090,815, filed on Nov. 5, 2020, now abandoned.
(60) Provisional application No. 62/930,814, filed on Nov. 5, 2019.

(51) Int. Cl. B60R 19/02

(52) U.S. Cl. CPC B60R 19/023

(57) ABSTRACT

An adapter panel for establishing a horizontal return and optional mount for accessories to a vehicle without a horizontal return. The adapter panel substantially conforming to a portion of a vehicle. The adapter panel solidly mounted to the underside of a vehicle, forming a surface upon which accessories can be mounted, or, alternatively having a lower surface having a reduced surface area in order to limit force applied to the panel and the vehicle. The panel further having an edge portion disposed along a perimeter, between the upper and lower surface, optionally securing the panel to the vehicle and deflecting obstacles, and one or more mounting points for removably attaching the protection panel to a portion of the exterior of a vehicle.

### PRIORITY CLAIM

This application is a continuation of U.S. patent application Ser. No. 18/087,773 filed Dec. 22, 2022, which is a continuation of U.S. patent application Ser. No. 17/090,815 filed Nov. 5, 2020, which claims priority to U.S. Provisional Patent Application Ser. No. 62/930,814, filed Nov. 5, 2019, all of which are hereby incorporated by reference in their entireties as if fully set forth herein.

### BACKGROUND OF THE INVENTION

Many modern cars include various aerodynamic features at their extremities. These features, as a consequence of their proximity to obstacles or the road surface, can often be easily damaged. Further still, some of these features are constructed in a manner that makes it previously impractical, or impossible, to mount any form of lower protection, such as that taught in U.S. Pat. No. 10,272,862, which is incorporated by reference in its entirety as if fully stated herein. Many manufactures have moved to including components with very small or nonexistent horizontal returns in order to save costs and simplify manufacturing.

The present invention seeks to remedy this problem by providing a novel solution to add protection to these previously vulnerable parts, and also to provide a platform on which to mount more traditional sacrificial protective plates.

### BRIEF DESCRIPTION OF THE DRAWINGS

Preferred alternative examples of the present invention are described in detail below with reference to the following drawings.

FIG. 1 is an installed view, looking upward, of a portion of an adapter panel according to an embodiment of the invention.

FIG. 2 is a top down view of the lower portion of an adapter panel according to an embodiment of the invention.

FIG. 3 is a top down view of the upper portion of an adapter panel according to an embodiment of the invention.

FIG. 4 is an exploded installed view of an adapter panel and an accessory according to an embodiment of the invention.

FIG. 5A-5B illustrates various aspects of a portion of the adapter panel depicted in FIG. 4.

### DETAILED DESCRIPTION OF THE INVENTION

The preferred embodiment of the invention is not limited in its application to the details of construction and the arrangement of components set forth in the following description or illustrated in the following drawings. The preferred embodiment of the invention is capable of other embodiments and of being practiced or being carried out in various ways. Also, it is to be understood that the phraseology and terminology used herein is for the purpose of description and should not be regarded as limiting. The use of “including,” “having,” or “comprising” and variations thereof herein is meant to encompass the items listed thereafter and equivalents thereof as well as additional items. Unless specified or limited otherwise, the terms “connected,” “supported,” and “coupled” and variations thereof, are used broadly and encompass both direct and indirect mountings, connections, supports, and couplings. It is also to be understood that “connected” and “coupled” are not restricted to physical or mechanical connections or couplings. Further, the use of absolute terms such as “must,” “will,” and the like, as well as specific quantities, plurals or singulars, are to be construed as being applicable to one or more of such embodiments, but not necessarily to all such embodiments. As such, embodiments of the invention may omit, or include a modification of, one or more features or functionalities described in the context of such absolute terms.

The present invention relates generally to devices, systems, and methods for, or to provide a mounting point for vehicle accessory products, increasing protection and resilience of portions of vehicles from being damaged. For example, embodiments of the present invention may, but are not limited to, be utilized to protect surfaces of vehicles from being damaged by debris, curbs, the road surface, or other articles that may cause damage to an exterior surface of a vehicle. Vehicle is understood to mean at least, but not limited to, cars, trucks, SUVs, boats, airplanes, ATVs, side-by-sides, tractors, motorcycles, scooters, bicycles, skateboards, single-wheel transporters, electric hoverboards, wheelchairs, and the like.

In one embodiment of the invention, a mounting adapter is provided. The adapter is configured to provide additional mounting areas to a vehicle with a small horizontal return, or no horizontal return. Vehicles without a horizontal return, or with a small horizontal return (under 0.5 inches) historically cannot accept accessories at the returnless area. In some embodiments, the adapter is configured to fill a negative space that previously lacked, or had a small horizontal return, thereby creating a suitable horizontal return. Installation of an adapter consistent with an embodiment of the present invention transforms the otherwise small horizontal return, or returnless area on the underside of a vehicle into a larger horizontal return. An example of a vehicle with a returnless area is the Chevrolet® CS Corvette®, especially those fitted with the optional ZS1 package, and carbon fiber splitters. An additional example of a vehicle with a small horizontal return is a Porsche® 991.2 GT3. These examples are purely exemplary, and not limiting, and simply provide exemplary configurations that can be enhanced by utilizing the teachings of the present invention. Generally, a horizontal return of less than 0.5 inches is smaller than would be optimum for maximum protection. Once a horizontal return is provided, via installation of an embodiment of the present invention, additional accessories may be installed thereon. Further, various embodiments of the present invention may provide an integrated scrape prevention style plate, such as those described in U.S. Pat. No. 10,272,862.

The larger horizontal return provided by the present invention, generally more than 0.5 inches, has various benefits, including: supporting vulnerable areas of the vehicle by filling in negative space, providing scrape protection by preventing parts of the vehicle from coming into contact with the road, and forming a base upon which to mount other accessories.

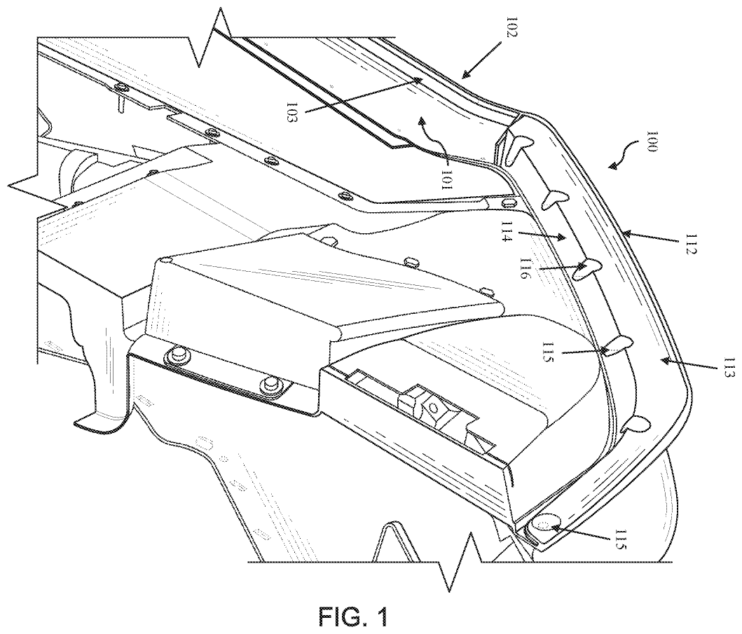

FIG. 1 depicts the underside of the front bumper area of a vehicle. A portion of the front lip, or splitter, 101 of the vehicle is partially covered by an embodiment of the present invention 100. The uncovered underside of the factory splitter 101 does not have a return, or any other means that would allow for effective attachment or use of protective products. Further still, the leading edge 102 of the splitter 101 is particularly vulnerable to damage, because it is not reinforced behind the leading edge 102, or underneath. When contacting an obstacle, such as a curb, or entering a steep driveway, the leading edge 102 of the splitter 101 will contact the obstacle and likely break. This is especially concerning where the splitter 101, or other vehicle part, is manufactured out of more expensive, and brittle, materials such as carbon fiber.

The present invention 100 serves multiple purposes. As depicted in FIG. 1, the present invention 100 may be installed on the vehicle where it fills the returnless space formed by, in this example, the vehicle's splitter 101. As shown, installation of the present invention forms a flat or substantially flat horizontal surface 113, from the leading edge 112 of the adapter 100, near the leading edge 102 of the splitter 101, to the back edge 114 of the adapter 100. In additional embodiments, the horizontal surface 113 may include various indents, depressions, or contours. In the depicted example, the trailing edge 114 of the adapter 100 is angled, in other examples the trailing edge 114 may have a radius profile, or other profiles similar to those taught in U.S. Pat. No. 10,272,862. In various embodiments, for example, the trailing edge 114 can be formed in such a manner to reduce the potential for snagging on an obstacle when the vehicle is reversing.

Referring back to FIG. 1, as shown, installation of the adapter 100 provides increased structure behind the leading edge 102 of the vehicle component, as depicted, a splitter 101, but the invention is not so limited to splitters, lips, or front bumpers, making the leading edge less susceptible to damage. Installation of the adapter 100 also provides, optionally, a surface 113 upon which to mount protective sacrificial products. Alternatively, these protective products, such as those discussed in U.S. Pat. No. 10,272,862, may be molded or manufactured directly into the adapter plate 100 of the present invention. When installed, the adapter plate 100 decreases the likelihood that the vehicle extremity 102/103 will bend and break because it reinforces the leading edge 102 by filling in the return-less area. It also provides a larger horizontal return, 113, upon which to mount accessories.

The bottom side of the adapter plate 100 includes a number of mounting locations 115. These mounting locations are positioned along the length of the adapter plate 100. The number of mounting locations may be more frequent or less frequent than depicted in FIG. 1. In some embodiments, an adapter plate 100 may take advantage of factory hardware. In such an embodiment, a number of mounting locations 115 are positioned above the factory hardware in order to mount the adapter plate 100. In additional embodiments, a combination of factory hardware and an additional mounting means may be used, for example, an adhesive may be used along the front edge 112 between the inner portion of the front lip 103 and the front edge 112 of the adapter plate 100.

As depicted in FIG. 1, the relative depth of the adapter 100 may change along its length. As depicted, the mounting relief holes 116 are different depths, due to the shape of the splitter 101, and correspond with deeper and shallower sections of the adapter 100.

In various embodiments of the present invention, the lower return surface 113 may not be perfectly flat, and instead may be contoured. In other embodiments, the lower surface 113 is flat along its length.

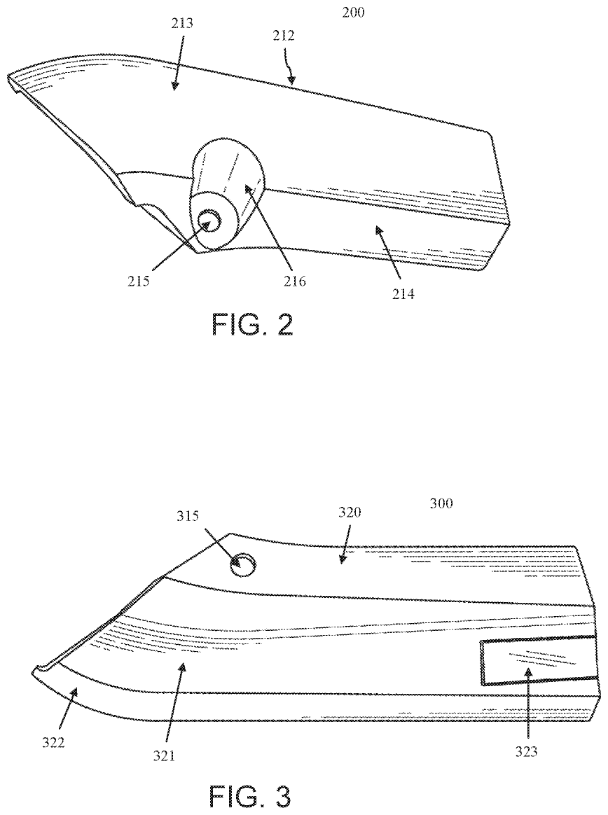

FIG. 2 depicts a portion of an adapter plate 200 according to an embodiment of the invention. The lower portion of the adapter plate 200, that is, the portion facing the road surface when installed, as depicted in FIG. 2, and also as shown in FIG. 1, may take many different shapes depending on the desired end use. For example, in some embodiments, the underside return portion 213 may be flat, as depicted in FIG. 1, for example, forming a smooth transition between the leading edge of the vehicle 102 and the leading edge of the adapter 212. This may have the benefit of being simpler to manufacture. In other embodiments, the adapter 200 may tuck in behind the leading edge of the vehicle 102 such that it is further from the road surface than the lowest point of the leading edge 102 of the vehicle. This arrangement may be useful, for example, where an adapter 200 is intended to accept additional accessories, such as those taught in U.S. Pat. No. 10,272,862, in order to place the accessory at the optimal height relative to the leading edge 102 and the road surface. In other embodiments, the underside 213 may be tapered, for example, transitioning from level where the adapter 200 has a leading edge 212 that is even with the leading edge 102 of the vehicle and becoming thinner away from the leading edge 212. In further embodiments, the underside surface 213 may be manufactured in order to have a lower surface area than the perimeter of the adapter 200. For example, an embodiment of the adapter 200 may be manufactured to include channels, ribs, bumps, or the like such that the total surface area of the portion designed to contact the ground, the lower surface 213, is less than the area encompassed by the perimeter of the adapter 200.

Embodiments of the present invention may include a number of attachment points 215. Depending on the embodiment, relief cuts 216 may be cut into the adapter to allow for access to the attachment point. For example, as depicted, relief cut 216 is made into the rear edge 214 and into the lower return 213, in order to provide access to the mounting hole 215 which is configured to accept, for example, a screw, nut, bolt, rivet or similar.

Some embodiments of the underside 213 of the adapter 200 according to an embodiment of the present invention may include areas for installation of other accessories. For example, the underside 213 may include tapped holes, or spaces for attachment of additional protective pieces. The underside 213 may also include areas where double-sided tape may be applied to attach accessories. The underside 213 may accept various types of hardware, including push fasteners, rivets, screws, and the like. In some embodiments, a channel may be included in the underside 213 to accept adhesives to adhere multiple parts together. In some embodiments, it may not be practical to tap the adapter 200 directly, and nutsert type fasteners made from harder material may be included and bonded to the adapter. In a preferred embodiment, the underside 213 is configured to accept the mounting of a sacrificial protective plate, such as the type described in U.S. Pat. No. 10,272,862.

FIG. 3 depicts the upper side, comprised of a middle portion 321, leading edge portion 322, and rearward portion 320, which face away from the road surface and into the vehicle, of a portion of an adapter 300 according to an embodiment of the present invention. The upper side of the present invention 300, as depicted in FIG. 3, preferably fits into the area of a vehicle that has no horizontal return, or a small horizontal return. For example, a 3D scan of the underside of the vehicle may be performed. That scan may be used to design an embodiment of the present invention which fills that area to create a smooth reinforced transition. For example, in certain embodiments, the middle portion 321 of the adapter 300 contacts a majority of the underside of the vehicle portion to provide maximum reinforcement. The upper leading edge portion 322, for example, may also fit up against the forward lip of the vehicle. Finally, the rearward upper section 320 may nest with the rearward portion of the portion of the vehicle. Further still, in many embodiments, the adapter 300 is fastened to the vehicle using mounting holes 315. In various embodiments, stock location fasteners from the vehicle may be used at various mounting holes 315. For example, as depicted in FIG. 1, the bottom side of the invention includes a number of holes for fasteners; these holes are also shown in FIGS. 2 and 3. The adapter 300 may accommodate the holes 315. Preferably, where possible, these holes correspond to a factory fastener, and allow the installation of the present invention without the need to drill additional holes in the vehicle. In some embodiments the fastener may be factory like, or a new type of fastener. In some embodiments, additional fasteners, or adhesives, may be used to apply the present invention. In other embodiments, only adhesives may be used. In the depicted embodiment, factory fasteners are utilized across the trailing edge, and adhesives are used closer to the front edge to provide a secure fit.

In certain embodiments, the adapter 300 may include a tag location 323 where a marketing or identification mark may be placed. In certain other embodiments, slogans, tradenames, or other identifying marks may be placed elsewhere on the adapter 300, and may be, for example, molded or designed into the product itself

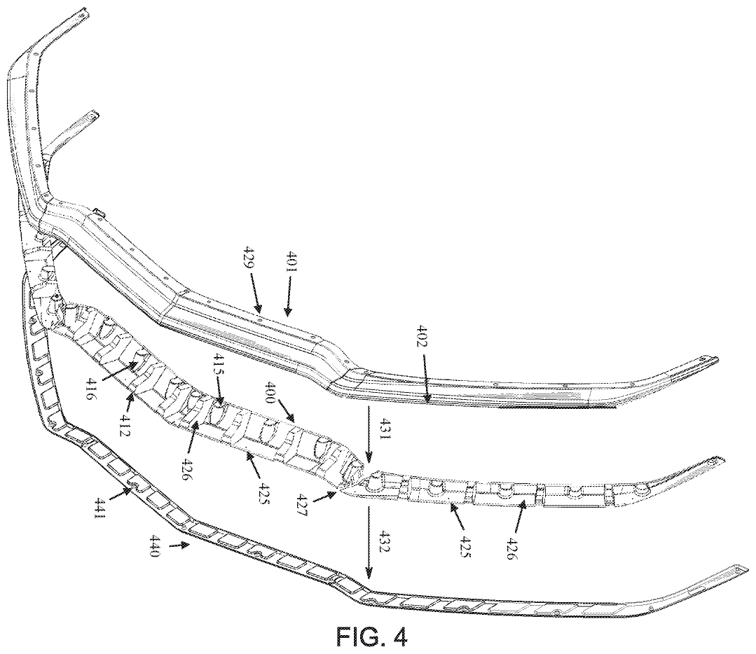

In additional embodiments of the present invention 300, the upper side may be more fragmented than that depicted in FIG. 3. For example, as seen in FIG. 4.

FIG. 4 depicts a vehicle part without a sufficient horizontal return 401, an adapter 400 according to an embodiment of the present invention, and an optional accessory 440 for mounting to the adapter 400.

As depicted, a portion of a vehicle, in this case a splitter 401, lacks a sizable horizontal return. An adapter 400 can be fit 431 to the splitter 401, as shown. The upper portion of the adapter 400, as shown, nests into the area without a horizontal return in the splitter 401, and rests against the leading edge 402 of the splitter 401.

The adapter 400 has a number of mounting reliefs 416 and mounting holes 415 that correspond with factory holes and fasteners 429 in the splitter 401. The adapter 400 also includes a number of ribs 426 along its length. These ribs 426 are shaped to match the splitter 401, and engage that splitter 401 while raising the adapter 400 to create a horizontal return. The ribs 426 are placed along the length of the adapter in order to provide structure to the adapter 400. The ribs 426 also may, depending on the embodiment, press against the inner portion of the leading edge 402 of the splitter 401 at points 412. The combination of the leading edge support 412 and corresponding rib 426 elevates the bottom portion (not shown) to create a return. The number and shape of ribs will depend on the particular embodiment. As shown, the shape and number of ribs 426 may also change along the length of one embodiment, for example, there may be thinner and more numerous ribs (near the center of adapter 400) or larger wider and less frequent ribs (near the outer portion of adapter 400). In certain embodiments, the rib 426 may not extend from the rear portion to the front edge, and instead may be positioned closer to the front edge as a stand-off, making contact with the leading edge of a splitter 401.

The adapter 400 may also be comprised of multiple pieces. For example, the adapter 400 may include a break 427, where one or more pieces separate from one another. This has the benefit of making packaging much more efficient and allows for easier manufacturing of smaller portions of an adapter 400. The adapter portions may link together at break 427, for example, by nesting or sharing a mounting hole, in order to configure them into a unitary piece. Alternatively, the adapter 400 portions may simply be separate at break 427.

In various embodiments, an adapter 400 may include, along its length, various mounting holes 425. These optional mounting holes 425 provide a point of attachment for optional accessories, such as a protective plate 440, and correspond with mounting holes in the accessory 441. The protective plate 440 may be mounted 432 to the adapter 440 and fastened thereto using the mounting holes 425. The mounting hole 425 may accept various types of hardware, including push fasteners, rivets, screws, and the like. In additional embodiments, the mounting hole 425 may be replaced by an adhesive locator. Adhesive may also be placed at other points, for example, on ribs 426 and rib tips 412 in order to adhere the adapter 400 to the splitter 401 in a manner that provides a secure platform to mount 432 an accessory 440 to the adapter 400.

In accordance with a method according to an embodiment of the present invention, a user with a vehicle without a suitable horizontal return may receive an adapter 400. The adapter 400 is preferably matched to the exact make and model of the vehicle and has a number of ribs 426 customized to fit neatly to the vehicle. The user, utilizing factory fasteners where available, or additional non-factory fasteners, as well as adhesive if applicable, offers up 431 the adapter 400 to the vehicle, and semi-permanently affixes the adapter 400 thereto. Optionally the user may then offer up 432 an additional protective device 440, such as a Scrape Armor® plate, to the adapter 400. The additional accessory 440, may then be affixed to the adapter 400 at various points along each.

According to such an embodiment, the upper side includes a series of ribs 426, or stand-offs, which engage the vehicle and position the lower surface at the correct point relative to the ground and the vehicle. In such an embodiment, the various ribs or standoffs are placed frequently enough to provide sufficient resilience to the adapter 400, and sufficient mounting strength. For example, the ribs or stand-offs may be placed at about 0.25 inches apart, or alternatively, from 0.1 to 6 inches apart, depending on the needs of the application. The ribs or standoffs may include a point for placing adhesive to create a semi-permanent bond between the rib or stand-off and the vehicle.

In various alternative embodiments, step 432 may be replaced by creating an all-in-one piece, where the adapter is configured to adapt to the vehicle, creating a negative return and where the adapter has an accessory, like 440, disposed directly, during the manufacturing process, onto its lower surface, creating a single piece part comprising the adapter 400 and accessory 440. In additional embodiments, the adapter 400 and accessory 440 may be manufactured separately and then permanently bonded.

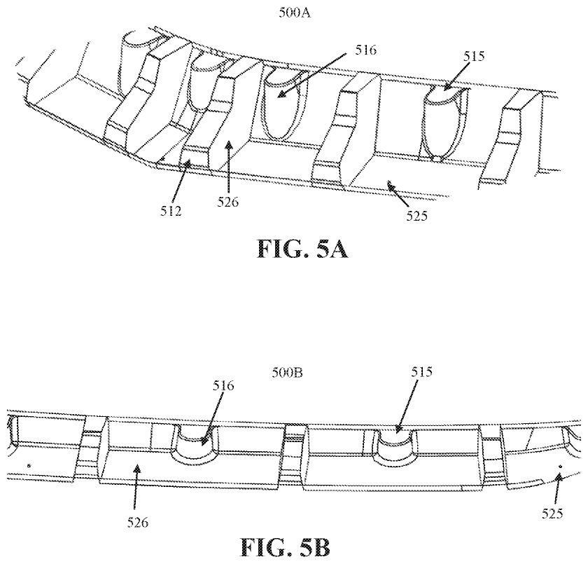

FIG. 5A and 5B depict portions of the underside of an adapter according to an embodiment of the present invention. Referring to FIG. 5A, one embodiment 500A of ribs 526 is depicted. As shown, a number of ribs 526 are positioned along the adapter 500A. More ribs may be positioned closer together in areas where increased strength is desired, or near intricate portions of the vehicle shape, where additional adhesion is appropriate. The adapter 500A also has a number of mounting reliefs 516 and mounting holes 515, as well mounting points 525 for accessories. Referring to FIG. 5B, an alternative rib 526 design is shown. Numerous rib designs are possible. The ribs may also take the form of standoffs, where they are positioned near the leading edge, and may have adhesive applied to them to attach to the inner leading edge of the vehicle, but where the stand-off does not extend rearward to the rear portion of the adapter. As depicted, the rib 526 of FIG. 5B are much larger. This embodiment 500B also retains the same features of other embodiments.

In order to ensure proper fitment, a catalog of designs may be created for specific vehicles and specific trim-levels of an individual vehicle or for individual design needs. The design may include, but is not limited to, for example, the overall shape, position of mounting holes, and overall contour of the vehicle panel. The adapter then may be produced by injection molding, multi-axis milling, single or multi-process machining, 3D printing, fabricating or other methods according to the design parameters and needs of the specific embodiment. For embodiments of the invention that include shape on the Z-axis, in order to better fit vehicle contours, various methods, such as multi-axis milling, 3D printing, injection molding, or fabrication may be preferable. The adapters are preferably easy to install, on account of their precise fit. An installer may also optionally apply various additional components in order to increase the appearance and integration of the part. Features of the various embodiments may be, for example, designed into a mold or carved out of a blank in order to achieve the benefits described herein.

Various embodiments of the present invention may be manufactured using, rotoforming, injection molding, multi-axis milling, single or multi-process machining, 3D printing, fabricating or other methods according to the design parameters and needs of the specific embodiment. In a preferred embodiment, the design of the adapter according to the present invention is determined by first creating a digital representation of the underside of the vehicle. Preferably, this is accomplished with a 3D scanning device. The 3D modelling may utilize at least one of a computer aided design (CAD) file and scanning of physical models, molds, and wire reconstructions. Once the design is achieved, the design can be manufactured according to the processes mentioned herein. The part can then be semi-permanently fitted to the vehicle. Where applicable, an additional sacrificial protective plate may also then be attached to the underside of the adapter. In some embodiments, the design of the adapter may be modified specifically to accept a protective plate, for example, with mounting holes, or with altered dimensions, such as depth, to accommodate and place the protective plate at the proper location.

All parts are preferably fabricated from any suitable material, including for example, but in no way limited to: plastic; polyethylene; ABS, PLA, PETG, PET, PETT, Nylon, Polycarbonate, HDPE, carbon fiber, textile materials; natural materials; wood; metal; or any other material or combination of materials capable of providing adequate stability, resilience, and appearance. In embodiments where the adapter with either be adhered to the vehicle using adhesive or adhered to a sacrificial plate using adhesive, a material that allows for adhesives to properly bond and form a secure connection may be used. In various embodiments, multiple types of material may be used at different parts of the adapter. This could allow, for example, the portion of the adapter that comes into contact with the underside of the vehicle to retain properties allowing for a strong bond using adhesive, which the underside of the adapter, designed to come into contact with the ground, could be made of material with a very low coefficient of friction, to prevent snagging and lower the force applied to the vehicle when coming into contact with obstacles.

The adapter may also be formed from multiple pieces. In certain embodiments, multiple pieces may be bonded together or fastened together to form a complete piece. For example, as depicted in FIG. 3, which is comprised of three separate pieces, multiple pieces may be used along the length of the vehicle splitter. This makes the complete part much smaller and easier to ship and manufacture. And, if one part is damaged, it may be replaced individually. Where the adapters are designed in multiple pieces, they may be manufactured with retaining pins, or guide pins, for example, that allow them to nest into each other neatly and securely. Adhesives may also be used.

Benefits, other advantages, and solutions to problems have been described above with regard to particular embodiments. Any benefit, advantage, solution to problem, or any element that may cause any particular benefit, advantage, or solution to occur or to become more pronounced are not to be construed as critical, required, or essential features or components of any or all the claims.

The terms “comprise”, “comprises”, “comprising”, “having”, “including”, “includes” or any variations of such terms, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the same.

While the preferred embodiment of the invention has been illustrated and described, as noted above, many changes can be made without departing from the spirit and scope of the invention. For example, an adapter panel may be used in other fields, or may not form a shape generally representative of a portion of a vehicle panel. Accordingly, the scope of the invention is not limited by the disclosure of the preferred embodiment. Instead, the invention should be determined entirely by reference to the claims that follow.

We claim:

1. An adapter panel for a vehicle component to establish a horizontal return, comprising:
an upper surface configured to engage with a portion of a vehicle, the portion of the vehicle lacking a horizontal return;
a lower surface opposite the upper surface, the lower surface configured to establish a horizontal return;
an edge portion disposed along a perimeter, between the upper and lower surface, the perimeter substantially conforming to the portion of the vehicle;
at least one mounting point for removably attaching the panel to the vehicle.
